(19) United States
(12) Patent Application Publication
(10) Pub. No.: US 2014/0188446 A1
(43) Pub. Date: Jul. 3, 2014

(54) SYSTEM PERFORMANCE PREDICTION METHOD, INFORMATION PROCESSING DEVICE, AND CONTROL PROGRAM THEREOF

(71) Applicant: Daichi Kimura, Tokyo (JP)

(72) Inventor: Daichi Kimura, Tokyo (JP)

(73) Assignee: NEC CORPORATION, Minato-ku, Tokyo (JP)

(21) Appl. No.: 14/126,686

(22) PCT Filed: Jun. 15, 2012
(86) PCT No.: PCT/JP2012/065931

§ 371 Date: Dec. 16, 2013

(30) Foreign Application Priority Data
Jun. 18, 2011 (JP) 2011-134566

(51) Int. Cl. G06F 11/34

(52) U.S. Cl. CPC G06F 11/3447
USPC 703/2

(57) ABSTRACT

An object of the present invention is to carry out a performance prediction which reflects actual behavior of a subject system which is a subject for which performance is to be predicted.

Disclosed is an information processing device, comprising: an I/O measurement unit which measures input and output of the subject system; an adjustment part substitution unit which, for a system model of the subject system which is configured from a plurality of partial system models, substitutes a designated partial system model with a black box which is connected to the input and output of the partial system model; a prediction output calculation unit which, on the basis of the system model of the subject system in which the designated partial system model is substituted with the black box, calculates a prediction output of the system model for the measured input of the subject system; and a model adjustment unit which adjusts the relation between the input and output in the black box such that a difference between the measured output of the subject system and the predicted output of the system model which the prediction output calculation unit has calculated is made smaller.

### TECHNICAL FIELD

The present invention relates to a technology conducting performance prediction which reflects an actual behavior (action) of a target system.

### BACKGROUND ART

In the above technical field, Patent Literature 1 (Japanese Patent Laid Open No. 2000-298593) discloses a method for predicting performance metrics, such as a throughput, a response, a resource usage rate, of a parallel computer in a multi-task environment by changing a parallel computer system into a queue model. In the prediction by the queue model, a parameter related to a system to be configured (e.g. processing time per one request (Demand)) is given in advance, and the performance metrics are predicted by using the parameter.

As a technology adjusting the parameter, Patent Literature 2 discloses a method for comparing an application with a log output of an application model corresponding to the application. In the method described in Patent Literature 2, a parameter of the application model is automatically adjusted and the adjusted parameter is reflected to the application model (hereinafter, referred to as “model” in some cases). In Patent Literature 2, the method is proposed, that improves accuracy of the performance prediction of the application by choosing an appropriate parameter corresponding to an execution environment of the application.

A device described in Patent Literature 3 changes a whole server computer system into a black box, provides a measurement transaction, and predicts the number of simultaneous processing by a simple established calculation which is different from a model based on a queue network.

### CITATION LIST

### Patent Literature

[Patent Literature 1]
Japanese Patent Laid Open No. 2000-298593

[Patent Literature 2]
Japanese Patent Laid Open No. 2002-215423

[Patent Literature 3]
Japanese Patent Laid Open No. 1998(H10)-187495

### SUMMARY OF THE INVENTION

### Technical Problem

In Patent Literature 1, the value given in advance may differ from a value in an actually configured target system (i.e. system to be targeted for performance prediction). The method disclosed in Patent Literature 1, therefore, includes the problem that a difference occurs between the performance metrics predicted by using the application model and performance metrics of the actually configured target system.

The method described in Patent Literature 2 (Japanese Patent Laid Open No. 2002-215423) aims at simulating a target system and adjusts the parameter of the model which is configured based on known information. Therefore, the technology described in Patent Literature 2 only discloses an adjustment technique for a parameter in the configured model.

Patent Literature 3 (Japanese Patent Laid Open No. 1998(H10)-187495) discloses a technology in which the whole target system is substituted with the black box and evaluation data on the model is predicted. In Patent Literature 3, a targeted model for evaluation is a simulation model of the target system which is configured based on the known information, like Patent Literature 2. Therefore, the device described in Patent Literature 3 cannot solve the problem that the difference occurs between the performance index predicted by using the model and the performance index of the target system actually configured.

A main object of the invention is to provide a technology solving the problem described above.

### Solution to Problem

In order to solve the above problem, the information processing device of the invention includes, I/O measurement means for measuring input and output of a performance prediction target system that is a subject of performance prediction, adjustment part substitution means for, with respect to a system model of the performance prediction target system that is configured from a plurality of partial system models, substituting a designated partial system model with a black box that is connected to input and output of the partial system model, predicted output calculation means for, on the basis of the system model of the performance prediction target system in which the designated partial system model is substituted with the black box by the adjustment part substitution means, calculating predicted output of the system model for the input measured by the I/O measurement means, and model adjustment means for adjusting a relation between the input and the output in the black box such that a difference between the output of the performance prediction target system measured by the I/O measurement means and the predicted output of the system model calculated by the predicted output calculation means is made smaller.

In order to solve the above problem, a system performance prediction method of the invention that is conducted by the information processing device, includes measuring input and output of a performance prediction target system that is a subject of performance prediction; for a system model of the performance prediction target system that is configured from a plurality of partial system models, substituting a designated partial system model with a black box which is connected to input and output of the partial system model; on the basis of the system model of the performance prediction target system in which the designated partial system model is substituted with the black box, in the substitution, calculating predicted output of the system model for the input measured for the performance prediction target system; and adjusting a relation between input and output in the black box such that a difference between the output measured for the performance prediction target system and the calculated predicted output of the system model is made smaller.

In order to solve the above problem, a control program (computer program) of the invention causing a computer to execute the functions of a I/O measurement function for measuring input and output of a performance prediction target system which is a subject of performance prediction; an adjustment part substitution function, for a system model of the performance prediction target system which is configured from a plurality of partial system models, substituting a designated partial system model with a black box which is connected to input and output of the partial system model; a predicted output calculation function, on the basis of the system model of the performance prediction target system in which the designated partial system model is substituted with the black box by the adjustment part substitution function, calculating predicted output of the system model for the input measured by the I/O measurement function; and a model adjustment function for adjusting a relation between the input and the output in the black box such that a difference between the output of the performance prediction target system measured by the I/O measurement function and the predicted output of the system model calculated by the predicted output calculation function is made smaller.

In order to solve the above problem, a system performance prediction method of the invention that is conducted by the information processing device, includes measuring input and output of a performance prediction target system which is a subject of performance prediction; for a system model of the performance prediction target system which is configured from a plurality of partial system models, substituting a designated partial system model with a black box which is connected to input and output of the partial system model; on the basis of the system model of the performance prediction target system in which the designated partial system model is substituted with the black box, in the substitution, calculating predicted output of the system model for the input measured for the performance prediction target system; and adjusting a relation between input and output in the black box such that a difference between the output measured for the performance prediction target system and the calculated predicted output of the system model is made smaller; and setting the predicted output measured on the system model as a result of performance prediction on the performance prediction target system, if the difference between the output measured for the performance prediction target system and the calculated predicted output of the system model becomes the smallest on the basis of the adjustment on the black box.

Further, the object is achieved not only by the method, the device, and the computer program having the above configuration, but by a computer-readable recording medium storing the computer program.

### Advantageous Effect of the Invention

In the invention, performance prediction which reflects an actual behavior of a target system for the performance prediction can be conducted.

### BRIEF DESCRIPTION OF DRAWINGS

FIG. 1 is a block diagram illustrating a configuration of an information processing device of a first exemplary embodiment of the invention,

FIG. 2 is a block diagram illustrating a functional configuration of an information processing device of a second exemplary embodiment of the invention,

FIG. 3A is a diagram conceptually explaining a system model in which a partial system model of a first example of the second exemplary embodiment of the invention is substituted with a black box,

FIG. 3B is a diagram illustrating a system model in which a partial system model of a second example of the second exemplary embodiment of the invention is substituted with the black box,

FIG. 3C is a diagram illustrating a system model in which a partial system model of a second example of the second exemplary embodiment of the invention is substituted with the black box,

FIG. 3D is a diagram illustrating a system model in which a partial system model of a second example of the second exemplary embodiment of the invention is substituted with the black box,

FIG. 4A is a block diagram illustrating a hardware configuration of the information processing device of the second exemplary embodiment of the invention,

FIG. 4B is a diagram conceptually illustrating a configuration of a system model database of the second exemplary embodiment of the invention,

FIG. 4C is a diagram illustrating configurations of a black box database, a model adjustment algorism and a model adjustment condition of the second exemplary embodiment of the invention,

FIG. 5 is a flowchart illustrating a control procedure of the information processing device of the second exemplary embodiment of the invention,

FIG. 6 is a block diagram illustrating a functional configuration of an information processing device of a third exemplary embodiment of the invention,

FIG. 7 is a block diagram illustrating a functional configuration of an information processing device of a fourth exemplary embodiment of the invention,

FIG. 8 is a block diagram illustrating a functional configuration of an information processing device of a fifth exemplary embodiment of the invention,

FIG. 9A is a diagram illustrating a first configuration of substitution order data of the fifth exemplary embodiment of the invention,

FIG. 9B is a diagram illustrating a second configuration of substitution order data of the fifth exemplary embodiment of the invention,

FIG. 10 is a diagram illustrating an example of a black box substitution order of the fifth exemplary embodiment of the invention,

FIG. 11A is a block diagram illustrating a hardware configuration of the information processing device of the fifth exemplary embodiment of the invention,

FIG. 11B is a diagram illustrating a configuration of a system model database of the fifth exemplary embodiment of the invention,

FIG. 12 is a flowchart illustrating a control procedure of the information processing device of the fifth exemplary embodiment of the invention,

FIG. 13 is a block diagram illustrating a configuration of an information processing system of a sixth exemplary embodiment of the invention.

### DESCRIPTION OF EMBODIMENTS

Referring to drawings, exemplary embodiments of the invention are described below in detail as examples. Constituent elements described in the exemplary embodiments are only examples, and the technical scope of the invention is not limited to those.

### First Exemplary Embodiment

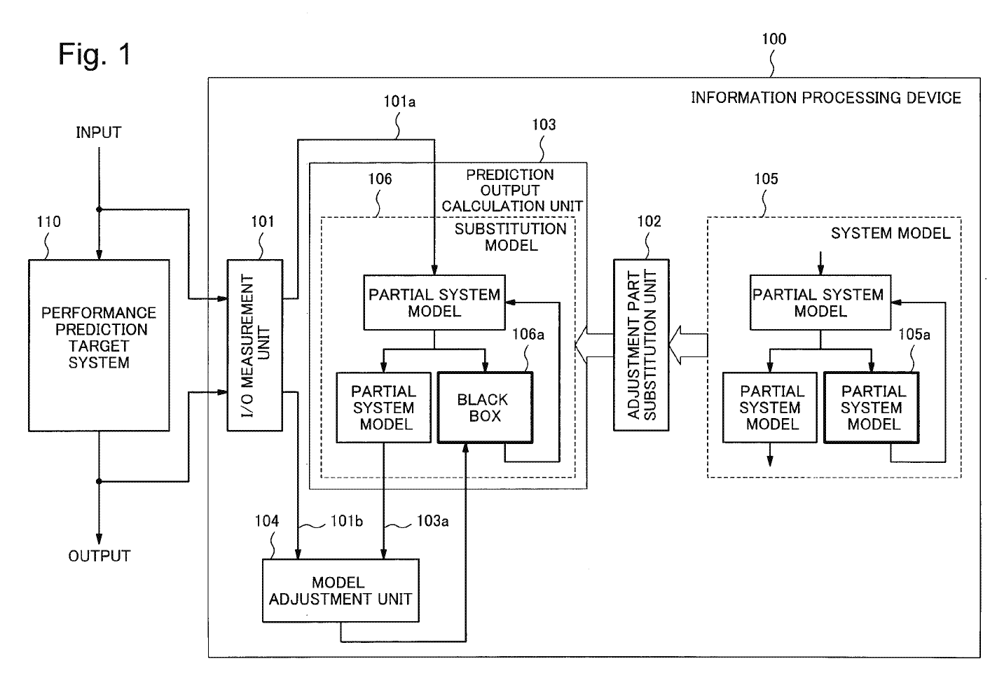

An information processing device 100 of a first exemplary embodiment of the invention is described by referring FIG. 1. FIG. 1 is a block diagram illustrating a configuration of an information processing device of the first exemplary embodiment of the invention. The information processing device 100 is a device which generates a system model of a performance prediction target system which is a subject for performance prediction.

As shown in FIG. 1, the information processing device 100 includes an input/output (I/O) measurement unit 101, an adjustment part substitution unit 102, a prediction output calculation unit 103, and a model adjustment unit 104.

The I/O measurement unit 101 measures input and output of a performance prediction target system 110. The performance prediction target system 110 is a subject whose performance is predicted by using the information processing device 100. A system model 105 shown in FIG. 1 by using a dashed line is a model corresponding to the performance prediction target system 110. As conceptually exemplified in FIG. 1, the system model 105 is configured by a plurality of partial system models 105a.

With respect to the system model 105, the adjustment part substitution unit 102 substitutes a designated partial system model 105a with a black box 106a connected to input and output of the partial system model 105a. A substitution model 106 shown in FIG. 1 by using a dashed line conceptually represents a substitution model of the performance prediction target system 110 which is in a state that the partial system model 105a designated at the adjustment part substitution unit 102 is substituted with the black box 106a.

The prediction output calculation unit 103 calculates, based on the substitution model 106, a predicted output 103a from the substitution model 106 with respect to an input 101a (i.e. measured input) measured by the I/O measurement unit 101.

The model adjustment unit 104 adjusts a relation between input and output in the black box 106a such that a difference between an output 101b of the performance prediction target system 110 measured by the I/O measurement means 101 (i.e. measured output) and the predicted output 103a from the substitution model 106 calculated by the predicted output calculation unit 103 is made smaller.

In the exemplary embodiment, the performance prediction which reflects an actual behavior of a target system for the performance prediction can be conducted.

### Second Exemplary Embodiment

Next, an information processing device of a second exemplary embodiment of the invention based on the above first exemplary embodiment is described. The information processing device of the exemplary embodiment substitutes a partial system model, among partial system models included a system model, designated through an operator's instruction, with a black box. The information processing device of the exemplary embodiment inputs a measured input of the performance prediction target system into a system model including the black box, and monitors a predicted output thereof. The information processing device of the exemplary embodiment adjusts the black box such that a difference between the measured output of the performance prediction target system and the predicted output becomes small.

In the exemplary embodiment, even though a fluctuation of performance occurs due to change of environment in the system model depending on the operator's instruction, the information processing device can substitute the designated partial system model with an appropriate black box in response to the fluctuation based on an operator's instruction. The information processing device of the exemplary embodiment can promptly conduct performance prediction reflecting an actual behavior of a target system for performance prediction

### <<Functional Configuration of the Information Processing Device>>

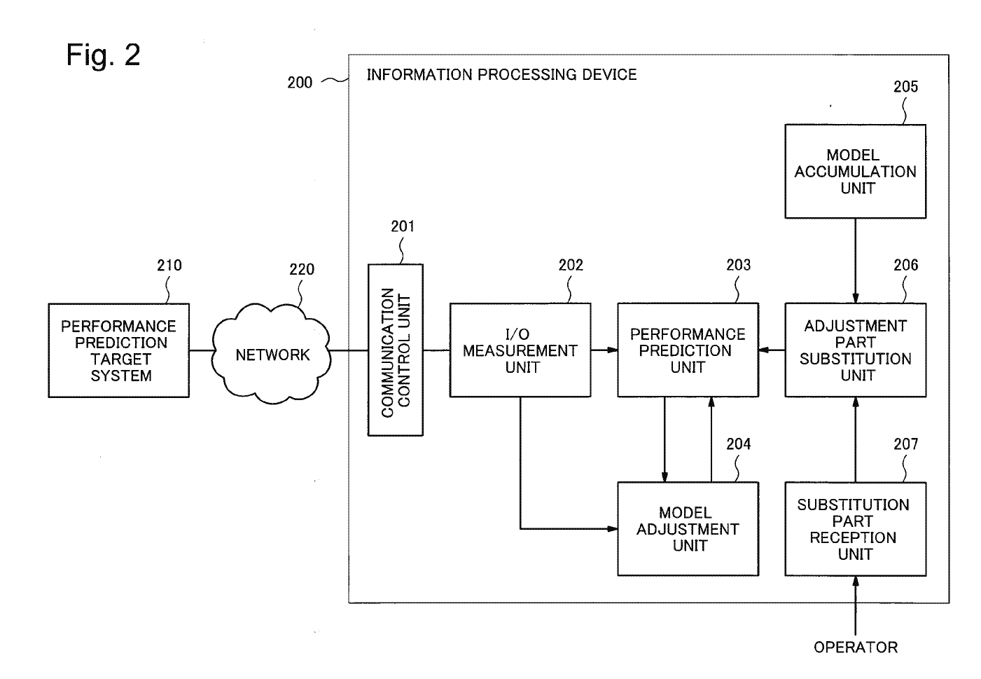

FIG. 2 is a block diagram illustrating a functional configuration of an information processing device 200 of the exemplary embodiment.

In FIG. 2, the information processing device 200 connects to a performance prediction target system 210 targeted for performance prediction through a network 220 in a communicatable manner. The information processing device 200 is a device, e.g. a computer, which works in accordance with a program (computer program/software program).

The performance prediction target system 210 is a subject for performance prediction in the exemplary embodiment. The performance prediction target system 210 is configured by one or more devices, e.g. one or more computers, which work in accordance with a program. When a plurality of devices are used, communication between the devices may be performed through the network 220 or through a communication cable directly connected. The network 220 may be Internet or a LAN (Local Area Network). The network 220 may take any configuration which enables communication between the information processing device 200 and the performance prediction target system 210.

The information processing device 200 includes a communication control unit 201, an I/O measurement unit 202, a performance prediction unit 203, a model adjustment unit 204, a model accumulation unit 205, an adjustment part substitution unit 206, and a substitution part reception unit 207.

The model accumulation unit 205 is a database (hereinafter, referred to as “DB”) which accumulates a system model representing a relation between input and output of a performance index of the performance prediction target system 210. The input is e.g. the number of requests which a system has to handle in a unit of time. The output is e.g. throughput of the system or a response time. However, the input and the output are not limited to those. If the input and the output can be described by a model as a relation between an independent variable and a dependent variable, the independent variable may be employed as the input and the dependent variable may be employed as the output.

The communication control unit 201 communicates with the performance prediction target system 210 through the network 220. The I/O measurement unit 202 has a capability to access the performance prediction target system 210 through the communication control unit 201 and measure input and output of the performance prediction target system 210.

The substitution part reception unit 207 receives a designation of a partial system model to be substituted with a black box through an operator's operation. The substitution part reception unit 207 may choose the partial system model to be substituted with the black box from an input device, like a keyboard, in accordance with the operator's operation. The substitution part reception unit 207 may acquire the partial system model to be substituted with the black box from a recording medium, like a hard disc drive (HDD) in a computer. The substitution part reception unit 207 may acquire the partial system model to be substituted with the black box from a server through a communication network, like Internet. The substitution part reception unit 207 substitutes the partial system model acquired by the substitution part reception unit 207 with the black box.

The black box in the exemplary embodiment is a mechanism which enables determination of an appropriate output for input based on learning or regression. For example, the mechanism may be achieved by a neural network or a hidden Markov model. The mechanism may be achieved by approximation by a polynomial function or a non-parametric regression function.

By using a relation between input and output of a system model in which the designated partial system model is substituted with the black box by the adjustment part substitution unit 206, the performance prediction unit 203 calculates a predicted output predicted by the system model with respect to the input of the performance prediction target system 210 measured by the I/O measurement unit 202.

The model adjustment unit 204 adjusts the black box based on the input and the output of the performance prediction target system 210 measured by the I/O measurement unit 202 and the predicted output predicted by the system model including the black box calculated by the performance prediction unit 203.

### <<System Model>>

An example of the system model and an example of substituting the partial system model with the black box in the exemplary embodiment are described below.

### First Example

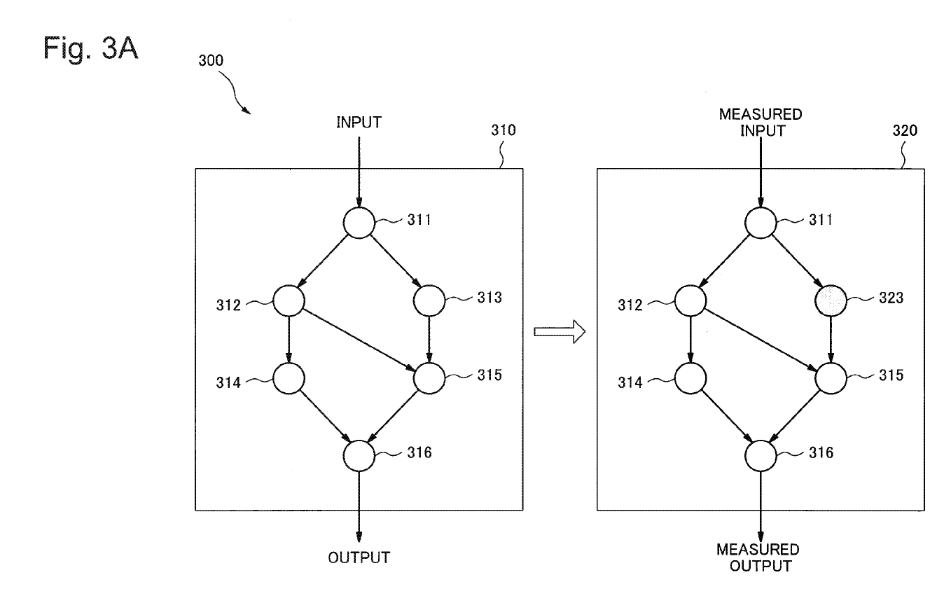

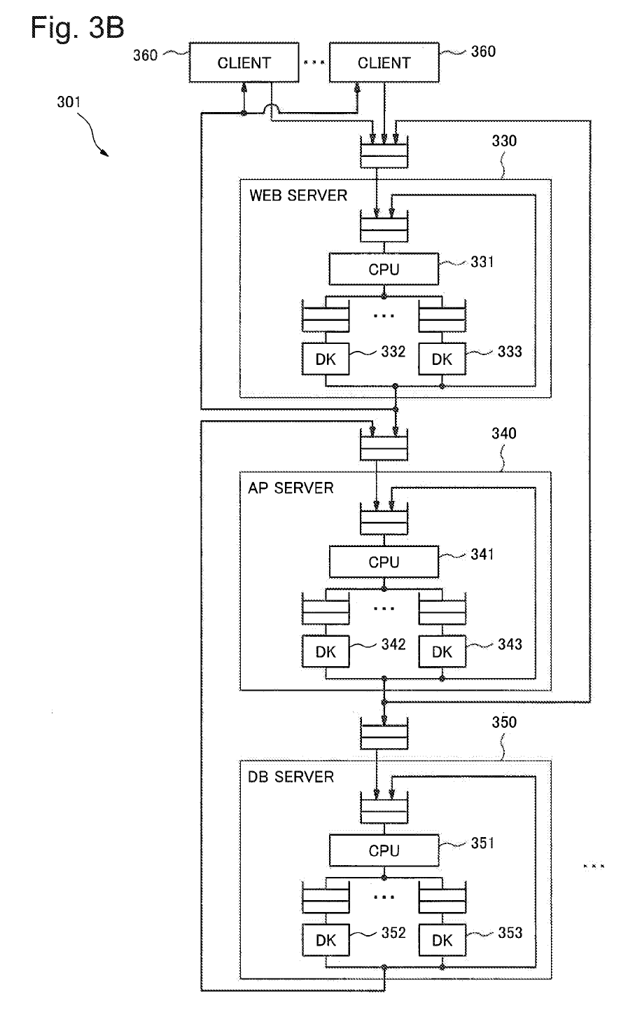

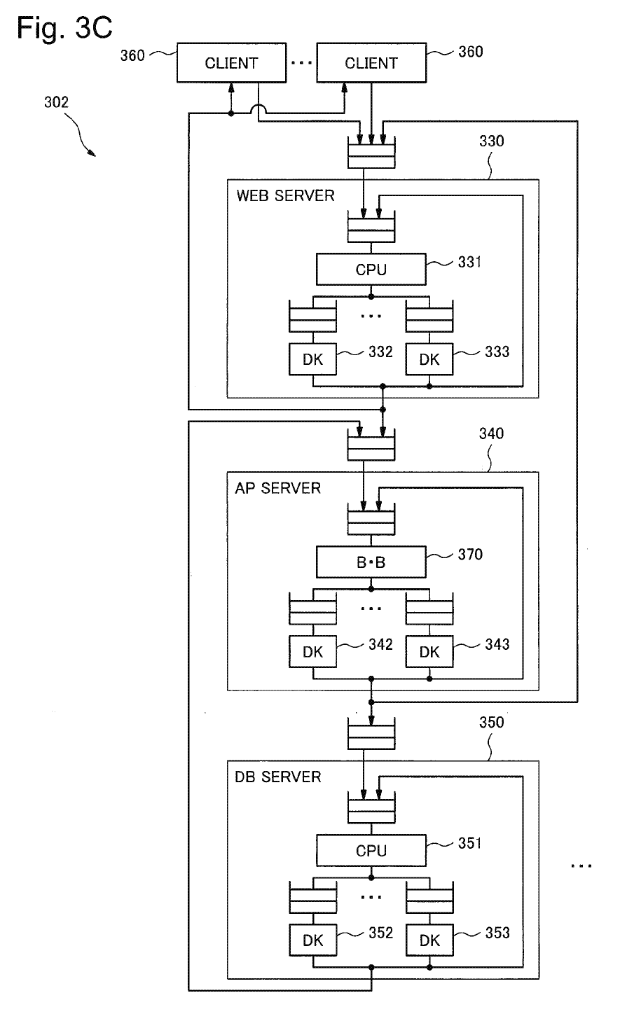

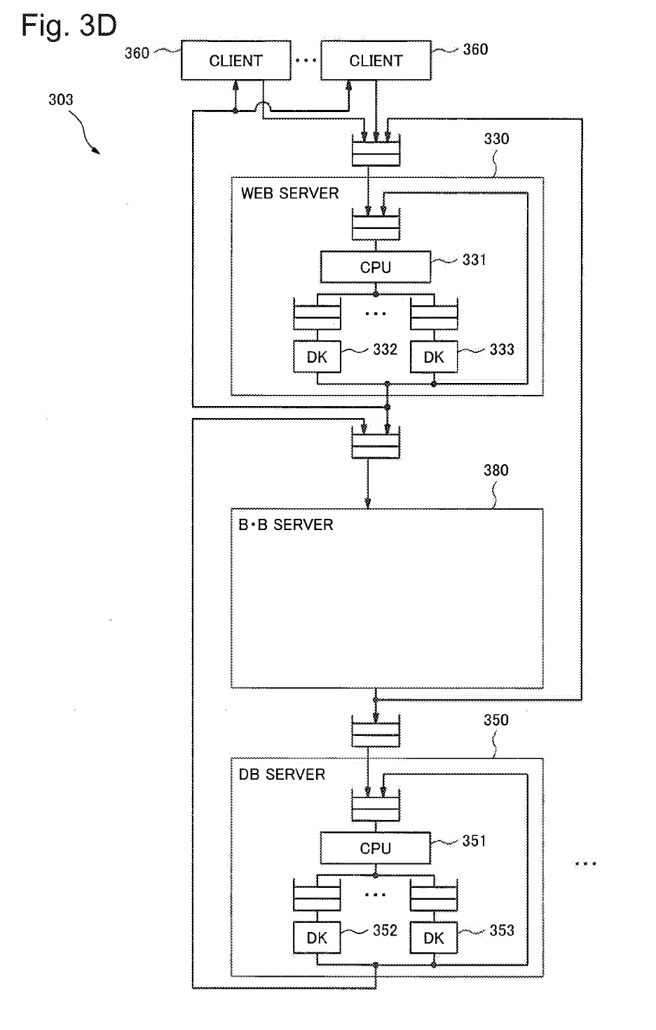

FIG. 3A is a diagram conceptually explaining a system model 300 in which the partial system model of a first example of the second exemplary embodiment of the invention is substituted with the black box. The left side of FIG. 3A shows an original system model 310 configured by a plurality of partial system models (modules 311 to 316). The right side of FIG. 3A shows a system model 320 in which one partial model (i.e. designated model: module 323) in the plurality of partial models is substituted with the black box.

In the example shown in FIG. 3A, the module means a model which simulates partial elements in a system. The module is, for example, a queue model simulates a behavior of a CPU (Central Processing Unit). It is not necessary for the module to correspond to each part of the system on a one-to-one basis. The module only has to be a constituent element which the system model requires to imitate a behavior of the performance prediction target system 210.

The module receives one or more inputs, conducts specified processing, and determines one or more outputs. The specified processing may be represented by an equation, e.g. y=exp (u) (u is input and y is output), or by a queue. The module just has to determine an output which is calculated or simulated, according to the predetermined procedure with respect to the received input, and not limited to the example described above.

In the example shown in FIG. 3A, the input to the system model 310 is initially sent to the module 311. The module 311 conducts specified processing and sends the output thereof to the modules 312 and 313. The modules 312 and 313 receive the output sent from the module 311 and conducts specified processing. The input and the output between the modules are performed and finally the output of the module 316 becomes the output of the system model 310. In the example shown in FIG. 3A, one type of input and one type of output are shown. However a plurality of inputs and a plurality of outputs can be also handled.

When the system model is graphically displayed, like in FIG. 3A, acquisition of the partial system model to be substituted with the black box may follow a user's input operation in which the module is clicked. When an identified ID (Identification) is allocated to each module, the acquisition of the partial system model may specified by the ID. If the module can be uniquely identified, the acquisition of the partial system model is not limited to the above examples. Also, a plurality of partial system models may be designated.

In the system model 320 shown in FIG. 3A, the module 313 is substituted with a black box 323. The information processing device of the example calculates a predicted output based on an input measured on the performance prediction target system 210 by using the system model 320, and adjusts the black box 323 while comparing the calculated predicted output with an output measured on the performance prediction target system 210.

### Second Example

FIG. 3B is a diagram illustrating a system model 301 in which a partial system model of a second example of the second exemplary embodiment of the invention may be substituted with the black box.

FIG. 3B shows an example of the system model 301 representing a server system including a Web server 330, an application server 340, and a DB server 350. Each of the servers is modeled by a CPU, a disc, and a queue connecting therebetween.

In following descriptions and drawings, the application server 340 may be described as “AP server”, the DB server 350 may be described as “DB server”, and the disc (storage device) may be described as “DK”.

The Web server 330 includes a CPU 331, two DKs 332, 333, and a queue. The AP server 340 includes a CPU 341, two DKs 342, 343, and a queue. The DB server 350 includes a CPU 351, two DKs 352, 353, and a queue.

FIG. 3C is a diagram illustrating a system model 302 in which a partial system model of the second example of the second exemplary embodiment of the invention is substituted with a black box. In FIG. 3C, the CPU 341 of the AP server 340 included in the system model 301 shown in FIG. 3B above described is substituted with a black box 370 (“B·B” in FIG. 3C).

FIG. 3D is a diagram illustrating a system model 303 in which a partial system model of the second example of the second exemplary embodiment of the invention is substituted with the black box. In FIG. 3C, the AP server 340 included in the system model 301 of FIG. 3B is substituted with a black box 380 (“B·B” in FIG. 3D).

By using system models 302, 303 after substitution shown in FIG. 3C and FIG. 3D, respectively, the performance prediction unit 203 calculates a predicted output which is a response from the performance prediction target system based on an access from a client 360 which is a measured input with respect to the performance prediction target system 210. The model adjustment unit 204 adjusts the black box 370 or the black box 380 while comparing with a measured output with respect to the performance prediction target system 210.

### <<Hardware Configuration of Information Processing Device>>

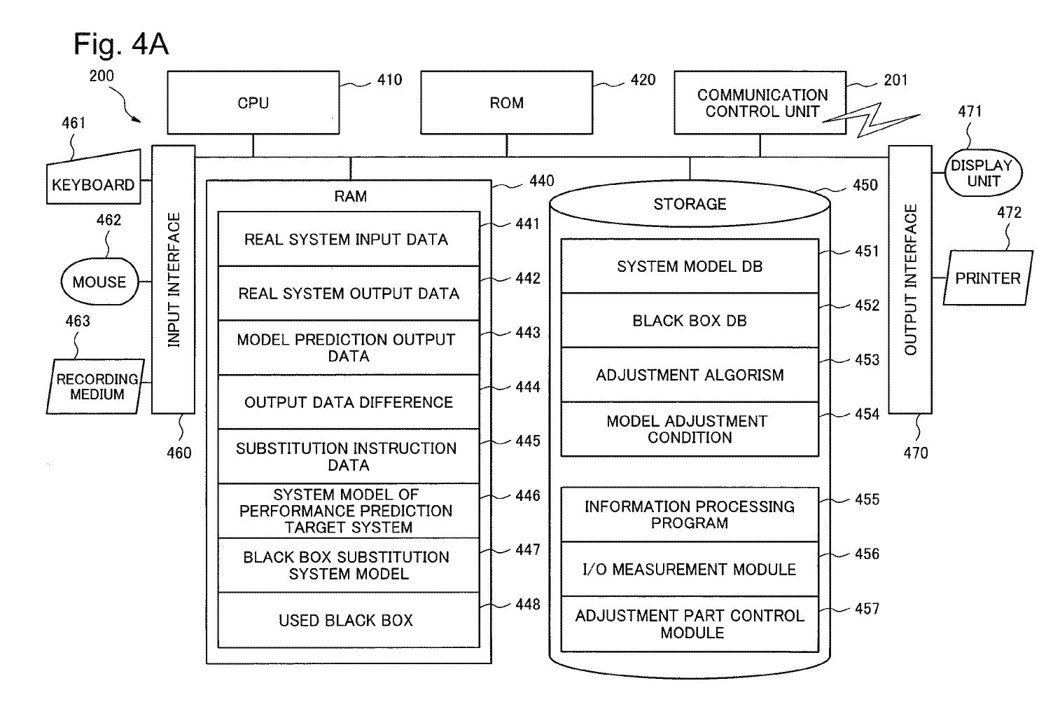

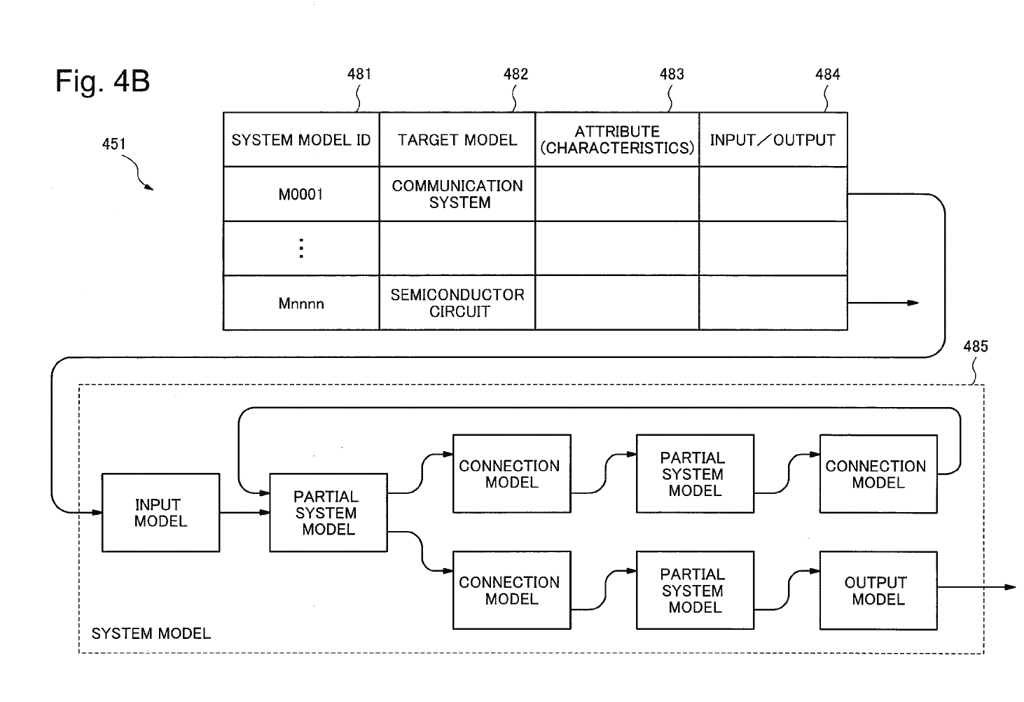

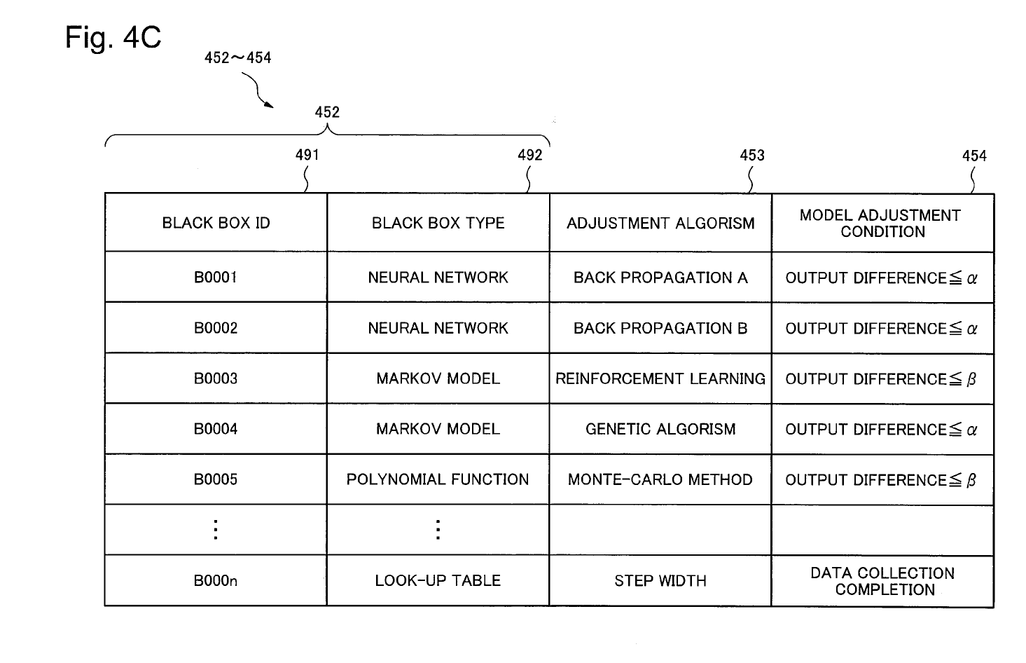

FIG. 4A is a block diagram illustrating a hardware configuration of the information processing device 200 of the second exemplary embodiment of the invention.

In FIG. 4A, a CPU 410 is a processor for calculation control which works by programs and achieves each functional configuration shown in FIG. 2. A ROM 420 stores fixed data and programs, like initial data and programs. The communication control unit 201 communicates with the performance prediction target system through a network.

A RAM 440 is a random access memory which the CPU 410 uses as a work area for a temporary storage. The RAM 440 includes a data storage area required to realize the exemplary embodiment. A numeral number 441 denotes input data (measured input) transmitted from the performance prediction target system 210 (hereinafter, referred to as “real system” in some cases). A numeral number 442 denotes output data (measured output) transmitted from the real system.

A numeral number 443 denotes model prediction output data outputted from the system model. A numeral number 444 denotes an output data difference which is a difference between the output data 442 transmitted from the real system and the model prediction output data 443 outputted from the system model. A numeral number 445 denotes substitution instruction data indicating a partial system model which is instructed by an operator and substituted with a black box.

A numeral number 446 denotes a system model of the performance prediction target system. A numeral number 447 denotes a system model in which a partial model is substituted with a black box based on the substitution instruction data 445. A numeral number 448 denotes a black box which is used when a partial model is substituted.

A storage 450 stores database, parameters, or following data or programs required for achievement of the exemplary embodiment. A numeral number 451 denotes a system model DB configuring the model accumulation unit 205 (refer to FIG. 4B). A numeral number 452 denotes a black box DB accumulating a black box which is used for substitution of a partial system model. A numeral number 453 denotes model adjustment algorism representing a procedure for adjusting a black model based on a system model in which a partial system model is substituted with a black box. A numeral number 454 denotes a model adjustment condition for determination of adjustment completion in black box adjustment in accordance with the model adjustment algorism 453.

The storage 450 stores following programs. A numeral number 455 denotes an information processing program executing whole of processes. A numeral number 456 denotes an I/O measurement module measuring input-output of a real system. A numeral number 457 denotes, based on a system model in which a partial system model is substituted with a black box, an adjustment part control module which controls the black box, in the information processing program 455.

An input interface 460 mediates an operator's operation and data input. The input interface 460 connects to, for example, a key board 461, a mouse (registered trade mark) 462 and a recording medium 463. An output interface 470 mediates outputs of an operation instruction to an operator and processing results. The output interface 470 connects to, for example, a display unit 471 and a printer 472.

In FIG. 4A, only data and programs required for the exemplary embodiment are illustrated. FIG. 4A does not show general-purpose data and programs, like OS (Operating System).

### (System Model DB)

FIG. 4B conceptually shows a configuration of a system model DB 451 of the second exemplary embodiment of the invention.

A system model ID 481 is an identifier identifying a system model. The system model DB 451, with respect to the system model ID 481, makes an association (connection) between a target model 482 targeted by the system model, an attribute 483 including the feature thereof, and input/output 484 indicating input and output of the system model, and stores them. Further the system model DB 451 includes a real system model 485. FIG. 4B shows an example of a queue model of a server as the system model 485 (refer to FIGS. 3B to 3D).

### (Black Box DB, Model Adjustment Algorism, and Model Adjustment Condition)

FIG. 4C is a diagram illustrating configurations of a black box DB 452, a model adjustment algorism 453 and a model adjustment condition 454 of the exemplary embodiment.

The black box DB 452 stores a black box type 492 which is associated with a black box ID 491 which is an identifier identifying a black box. The model adjustment algorism 453 and the model adjustment condition 454 which are associated with the black box ID 491 are stored therein.

FIG. 4C illustrates, as examples of the black box type 492, a neural network, a Markov model, polynomial function, a look-up table, or the like. The black box type 492 is not limited to those. The black box type 492 may include, for example, a non-parametric regression function. The exemplary embodiment prepares various black boxes which is applicable to various performance prediction target systems, as the black box type 492. Regarding the black box type, a plurality of black boxes are prepared with respect to the same type. The types of the plurality of black boxes may differ from one another in a configuration of the black box, the model adjustment algorism, and the model adjustment condition.

If the black box is the neural network, the model adjustment algorism 453 my choose each synapse weight as a parameter to be adjusted, and determine an initial value and an adjustment step for the parameter. If the black box is polynomial approximation, the model adjustment algorism 453 may choose each coefficient, as a parameter to be adjusted, and determine an initial value, an adjustment order, and an adjustment step for the parameter. The model adjustment algorism 453 may give a random value, as the initial value for the parameter. Also, the model adjustment algorism 453 may preliminarily give a value simulating a behavior of the partial system model before substitution, as the initial value for the parameter.

In FIG. 4C, two “neural networks” are prepared as the black box type 492, and, as the model adjustment algorism 453 associated therewith, “back propagation A” and “back propagation B” are set, respectively. In FIG. 4C, two “Markov models” are prepared as the black box type 492, and as the model adjustment algorism 453 associated therewith, “reinforcement learning” and “genetic algorism” are set, respectively. In FIG. 4C, further “polynomial function” is prepared as the black box type 492, and “Monte Carlo algorism” is set as the model adjustment algorism 453 associated therewith. Since the “look-up table” of the black box type 492 shown in FIG. 4C represents a data collection function, a step width in data collection is set as the model adjustment algorism 453.

The model adjustment unit 204 may compare an output measured in the performance prediction target system 210 with a predicted output predicted by a system model, and may determine that adjustment is completed if the error (difference) is equal to or less than predetermined accuracy. In the exemplary embodiment, when the model adjustment condition 454 is satisfied, the model adjustment unit 204 determines that a system model including a black box is able to predict a behavior (action) of the real system within a predetermined accuracy and completes adjustment.

As timing to determine adjustment completion in the exemplary embodiment, following cases are exemplified;
A case in which even though the given number of adjustments are conducted, the error does not change, i.e. a case in which it is regarded that the adjustment process reaches an equilibrium state,
A case in which the predetermined number of adjustments are conducted.

The information processing device of the exemplary embodiment may store procedures of changing into substitution of other partial system model, changing a black box type, or the like, as measures which are carried out when predetermined conditions are not satisfied after the given number of adjustments are conducted and the adjustment becomes ineffective.

The information processing device of the exemplary embodiment exemplified in FIG. 4C uses the condition that the error which is a difference between a measured output of the performance prediction target system and a predicted output of a system model including a black box is equal to or less than a predetermined threshold value, as the model adjustment condition 454 with respect to the neural network, the Markov model, and the polynomial function. The information processing device of the exemplary embodiment exemplified in FIG. 4C uses two threshold values, α, β, as the above described threshold value as the model adjustment condition 454. The information processing device of the exemplary embodiment exemplified in FIG. 4C uses an appropriate one from among α and β, in response corresponding to the black box type and the model adjustment algorism. Being used for condition determination of the adjustment completion, based on the difference between the measured output and the predicted output, the threshold values may be the same value. By adjusting those threshold values, accuracy of the model adjustment may be changed depending on a type or a purpose of the performance prediction target system 210.

### <<Control Procedure of Information Processing Device>>

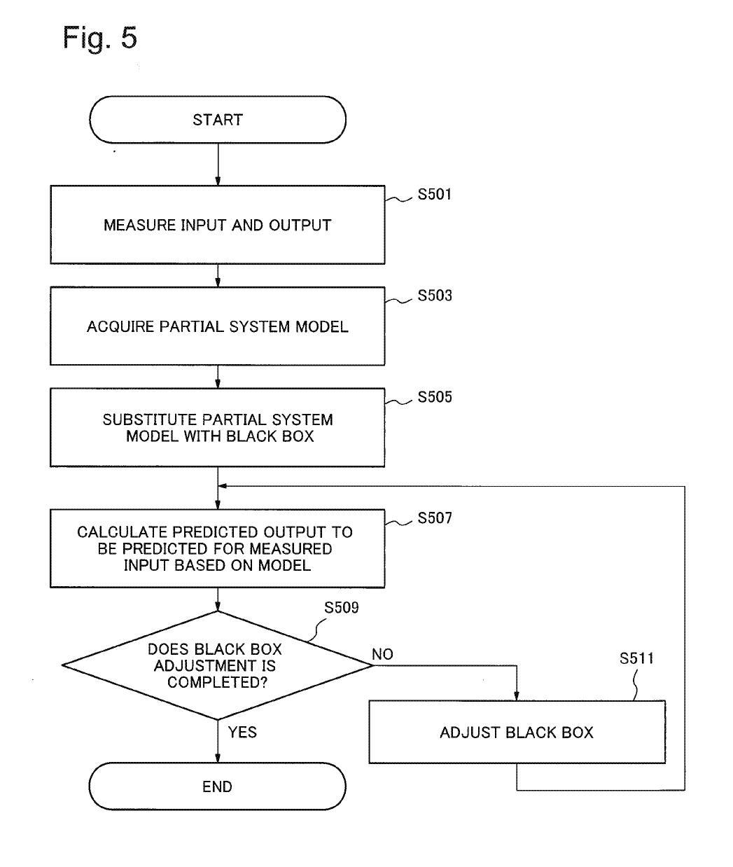

FIG. 5 is a flowchart illustrating a control procedure of the information processing device 200 of the second exemplary embodiment of the invention. The CPU 410 shown in FIG. 4A performs the procedures described in the flowchart while using the RAM 440, and achieves respective functional configurations shown in FIG. 2.

The CPU 410 accesses the performance prediction target system 210 through the network 220 and measures input and output of the performance prediction target system 210 (step S501).

The CPU 410 acquires, in accordance with an operator's input operation, information of a partial system model which is substituted with a black box and adjusted, and is included in a system model stored in the system model DB 451 (step S503). The CPU 410 may acquire information of a partial system model which is substituted with a black box and adjusted, in accordance with instructions from a server through a communication network, e.g. Internet.

The CPU 410 substitutes the partial system model designated as an adjustment subject with a black box (step S505).

Suppose that when the module 313 in the system model 310 shown in FIG. 3A is designated as the partial model, the CPU 410 substitutes the module 313 with the black box 323. The substituted black box 323 gives an output to the module 315 in response to an input from the module 311. If a plurality of the designated partial system models exist, the CPU 410 substitutes each of modules with black boxes.

Next, by using a relation between input and output of the system model in which the partial system model is substituted with a black box, the CPU 410 calculates a predicted output predicted by the model with respect to the input (measured input value) which is acquired from the performance prediction target system 210 in step S501 (step S507).

Next, the CPU 410 determines whether or not adjustment of the black box is completed, based on the model adjustment condition 454 (step S509). When determining that the adjustment of the black box is completed (YES in step S509), the CPU 410 completes processing.

If the adjustment of the black box is not completed (NO in step S509), the CPU 410 carries out step S511. The model adjustment condition 454 for determination of adjustment completion of the black box is shown in FIG. 4C.

The CPU 410 adjusts the black box in accordance with the model adjustment algorism 453, based on the input and the output (measurement results) acquired from the performance prediction target system 210 in step S501 and based on the predicted output of the system model calculated in step S507 (step S511). After adjusting the black box in step S511, the CPU 410 calculates again a predicted output predicted by the model including the adjusted black box, in step S507.

In the exemplary embodiment, the CPU 410 adjusts the black box by using a method, e.g. learning or approximation such that a difference between the predicted output of the system model by calculation and the output (measured output value) acquired from the performance prediction target system 210 is made smaller. By using, as an evaluation function, the difference between the output (measured output value) acquired from the performance prediction target system 210 and the predicted output of the system model by calculation, the CPU 410 corrects a parameter of the black box by conducting reinforcement learning, genetic algorism, or Monte Carlo algorism. For example, if the black box is the neural network, the CPU 410 corrects each synapse weight. If the black box is the polynomial approximation, the CPU 410 corrects each coefficient.

In the exemplary embodiment, even though a partial element of a system model corresponding to input-output of a black box (input-output of the module 312 in the example of FIG. 3A) cannot be directly measured, the CPU 410 can adjust the black box by setting, as an evaluation function, a difference between an measured output of a real system and a predicted output predicted by a model.

If partial elements of a system model corresponding to input-output of the black box can be directly measured, supervised learning, like back propagation, or a least-square method may be used in order to bring a predicted output of the black box close to a measurement result of an output of the partial elements.

### Third Exemplary Embodiment

An information processing device of a third exemplary embodiment of the invention based on the above mentioned the first and the second exemplary embodiments is described below. The information processing device of the exemplary embodiment differs from the second exemplary embodiment in that a partial system model to be substituted with the black box is designate not from the outside, like an operator, but in its own device. In the exemplary embodiment, the information processing device preferentially substitutes a part of a system which is influenced from outer environment or a part of system including a lot of rounding in a partial system model, with the black box, depending on a type of the system model. In the exemplary embodiment, since operator's operation is simplified, the information processing device can quickly conduct performance prediction reflecting an actual behavior of a target system.

### <<Functional Configuration of Information Processing Device>>

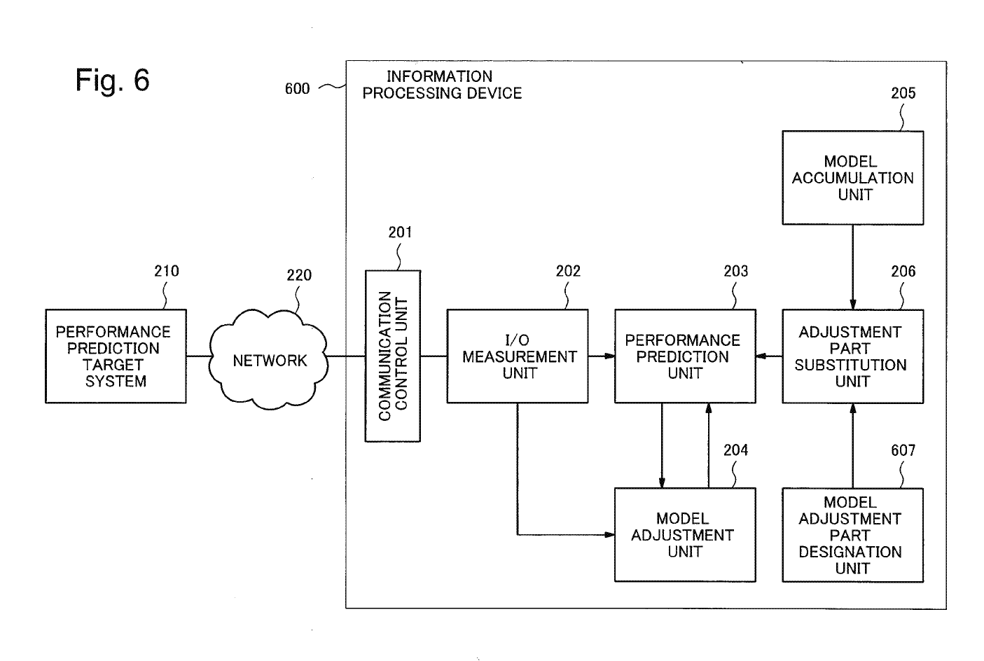

FIG. 6 is a block diagram illustrating a functional configuration of an information processing device 600 of the third exemplary embodiment of the invention.

Regarding FIG. 6, a part which is different from FIG. 2 of the second exemplary embodiment is described. The other configurations and operations are the same as those of the second exemplary embodiment. The same numeral number is used with respect to the same configuration as the second exemplary embodiment, and detailed descriptions on the same configuration as that of the second exemplary embodiment are omitted in the exemplary embodiment.

A model adjustment part designation unit 607 sends information designating a partial system model to the adjustment part substitution unit 206 in order to preferentially substitute the part of a system which is influenced from outer environment or the part of a system including a lot of rounding in a partial system model, with the black box, depending on a type of the system model.

### Fourth Exemplary Embodiment

An information processing device of a fourth exemplary embodiment of the invention based on the above mentioned the first and the second exemplary embodiments is described below. The information processing device of the exemplary embodiment differs from the second exemplary embodiment in that validity of a system model is evaluated after adjustment of the black box is completed. When the system model in which adjustment of a black box is completed is inappropriate as the model of the real system, the information processing device of the exemplary embodiment can avoid performance prediction by the inappropriate system model.

### <<Functional Configuration of Information Processing Device>>

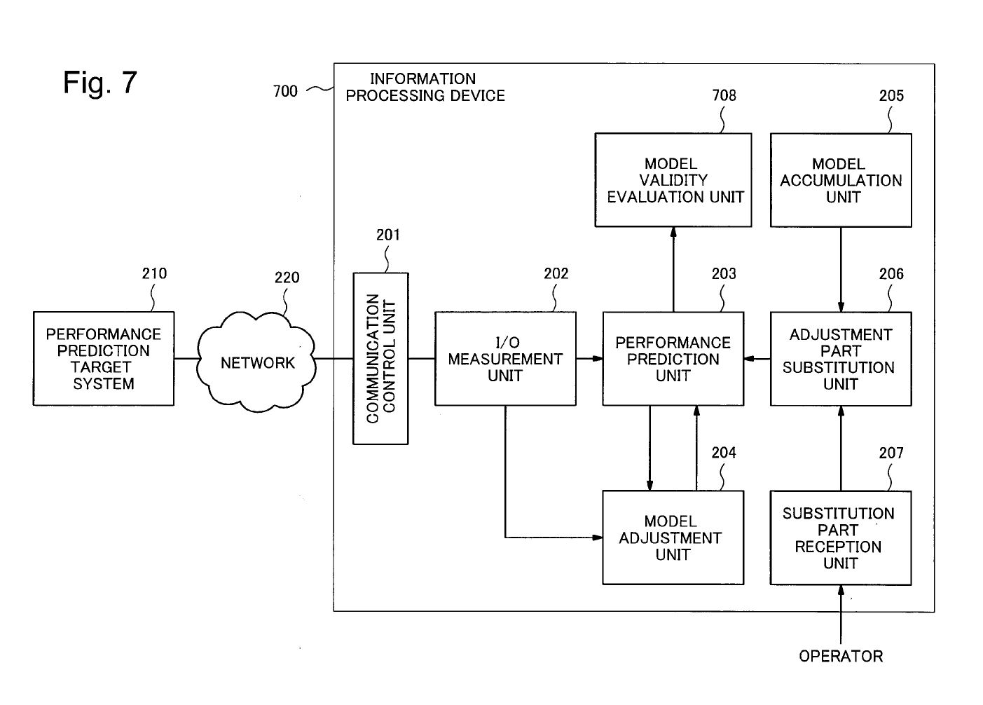

FIG. 7 is a block diagram illustrating a functional configuration of an information processing device 700 of the fourth exemplary embodiment of the invention,

Regarding FIG. 7, a part which is different from FIG. 2 of the second exemplary embodiment is described. The other configurations and operations are the same as those of the second exemplary embodiment. The same numeral number is used with respect to the same configuration as the second exemplary embodiment, and detailed descriptions on the same configuration are omitted in the exemplary embodiment.

A model validity evaluation unit 708 evaluates whether or not it is appropriate to use the system model for performance prediction for the performance prediction target system 210, with respect to the system model after adjustment of a black box. If the model validity evaluation unit 708 determines that use of the model is appropriate as the result of the evaluation, the information processing device 700 uses the system model after the adjustment for performance prediction for the performance prediction target system 210. On the other hand, if the model validity evaluation unit 708 determines that use of the model is inappropriate as the result of the evaluation, the information processing device 700 informs an operator of the determination result.

The model validity evaluation unit 708 evaluates whether or not the model after the adjustment of the black box is appropriate, in a following way. For example, when a part of the designated module is substituted with a black box, the black box is adjusted under influence of the designated module. Since a black box is strongly influenced from the module including the black box, and adjusted, when the module to be really corrected is designated, variance (discrepancy) of a behavior (action) between the model and the actual system is confined within the module. In this case, the influence is not extended to the outside of the module. Therefore the black box in the case includes relatively simple configuration.

If the module which should not be really corrected is designated, variance of a behavior between the model and the actual system appears outside the module. In this case, since the variance is intended to be adjusted by the black box included in the module which should not be corrected, the black box has a complicated configuration.

The model validity evaluation unit 708 may determine the more simple a configuration of the black box is, the more appropriate the model after adjustment is. That the configuration of the black box is simple means, for example, that the number of terms is small if the black box is the polynomial function, and that the number of neurons or synapses is small in case of the neural network. This is applicable to a case in which a module configuring a system is substituted with a black box. Even in a situation in which the module is substituted with a whole of the system, or even in a situation in which a part of the module is substituted with a module, as mentioned above, simplicity of black box configuration is an evaluation criterion for a system model including the adjusted black box.

In order to evaluate validity of the adjusted model, such like Akaike Information Criterion (AIC) or Bayesian Information Criterion (BIC), which are general index for evaluation of a model quality, may be adopted as evaluation criteria.

The evaluation criterion for evaluation of model validity is not limited to the above examples. Any evaluation criterion may be adopted which is appropriate for an evaluation criterion of a system model including a black box.

### Fifth Exemplary Embodiment

An information processing device of a fifth exemplary embodiment of the invention based on the above mentioned the first and the second exemplary embodiments is described below.

The information processing device of the exemplary embodiment differs from the information processing unit of the above mentioned exemplary embodiment in that a partial system model is consequently substituted with a black box, and the system model is adjusted, then a system model which is appropriately substituted in the adjusted system models is evaluated, and a result of the evaluation is sent to an operator.

In the exemplary embodiment, even when it is not preliminarily understood which partial model has to be corrected, the information processing device of the exemplary embodiment presents an appropriately adjusted model. According to the information processing device of the exemplary embodiment, a model which can perform performance prediction reflecting an actual behavior of a system is obtained. Further, according to the exemplary embodiment, when a part of a partial system model is substituted with a black box, the black box is adjusted while strongly receiving influence of the partial system model. Depending on whether or not variance of a behavior between a model and an actual system is confined within the partial model, validity of the adjusted model is widely changed. By using the characteristics, the reason on whether or not adjustment of the designated partial model is appropriate is given.

### <<Functional Configuration of Information Processing Device>>

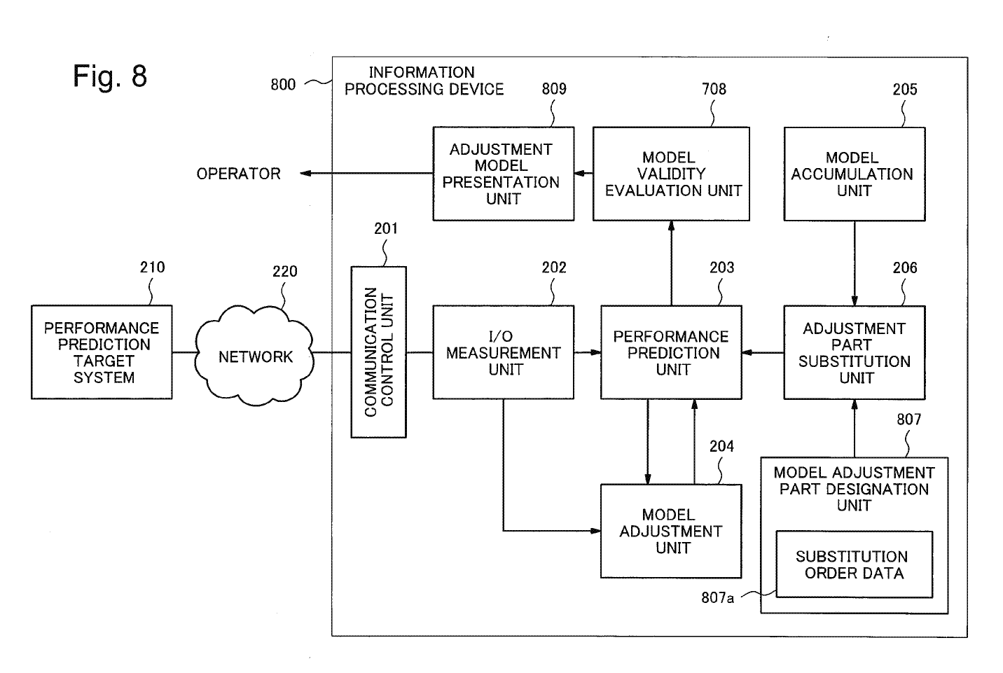

FIG. 8 is a block diagram illustrating a functional configuration of an information processing device 800 of a fifth exemplary embodiment of the invention.

Regarding FIG. 7, a part which is different from FIG. 2 of the second exemplary embodiment is described. The other configurations and operations are the same as those of the second exemplary embodiment. The same numeral number is used with respect to the same configuration as the second exemplary embodiment, and detailed descriptions on the same configuration are omitted in the exemplary embodiment.

A model adjustment part designation unit 807 includes substitution order data 807a storing an order of partial system models to be substituted. The model adjustment part designation unit 807 designates a partial system model or a part thereof, which is substituted with a black box, to the adjustment part substitution unit 206, according to the order (information representing order) stored in the substitution order data 807a.

The model validity evaluation unit 708 determines, like the fourth exemplary embodiment, whether or not it is appropriate that respective system models in which black boxes are consecutively substituted and adjusted are used for performance prediction by the performance prediction target system 210.

As a result of validity evaluation by the model validity evaluation unit 708, an adjusted model presentation unit 809 presents a system model which exceeds the criterion of validity. As presentation method for the system model, for example, the adjusted model presentation unit 809 may display a list of system models which exceed the criterion of validity together with evaluation values of the validity. As another method for presenting the system model, for example, the adjusted model presentation unit 809 may present the system having evaluation of the highest validity. As presentation method for the system model, for example, the adjusted model presentation unit 809 may display on a screen, or record in a storage device (recording medium), e.g. a hard disc drive.

### (Substitution Order Data)

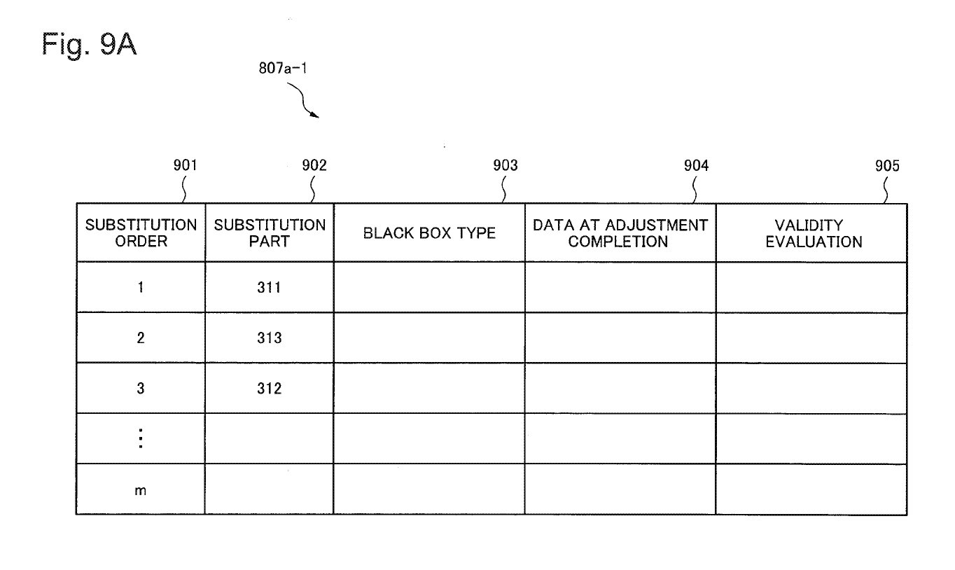

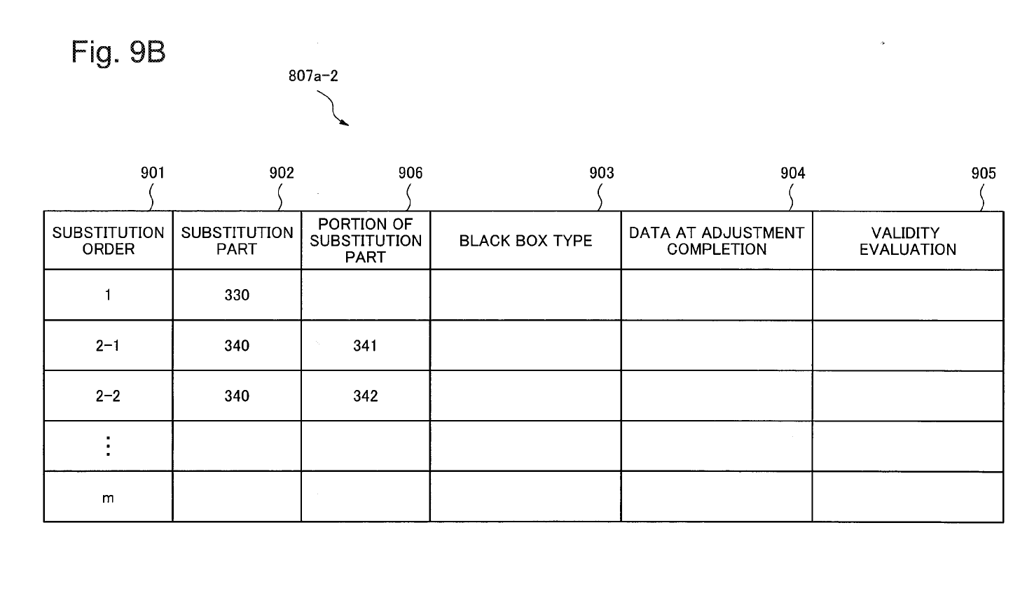

FIG. 9A is a diagram illustrating a first configuration 807 a-1 of substitution order data 807a of the fifth exemplary embodiment of the invention.

Following various pieces of information are associated and stored in the first configuration 807 a-1 in a substitution order 901 as shown in FIG. 9A.

substitution part 902: information representing a part of a system to be substituted with a black box,

black box type 903: information representing a type of a black box,

data at adjustment completion 904: information representing a state of a black box whose adjustment is completed,

validity evaluation 905: information representing an valuation result of validity.

FIG. 9A shows a selection order for the module in FIG. 3A. The data at adjustment completion 904 and the validity evaluation 905 may be stored in the model validity evaluation unit 708 or in the adjusted model presentation unit 809.

FIG. 9B is a diagram illustrating a second configuration 807a-2 of substitution order data 807a of the fifth exemplary embodiment of the invention.

FIG. 9B illustrates an example including a case in which a part of a system to be substituted with a black box is not only a partial system model, but a portion (part) of the partial system model. The example shown in FIG. 9B discloses a case in which each server in FIG. 3B is substituted with a black box and a case in which an element included in the server is substituted with a black box. In each item in FIG. 9B, the same numeral number as that of FIG. 9A has the same content. A “Portion of substitution part” 906 which is added in FIG. 9B represents the CPU 341 and the DK 342 in the AP server 340 which is the same substitution part of a system.

### (Example of Black Box Substitution Order)

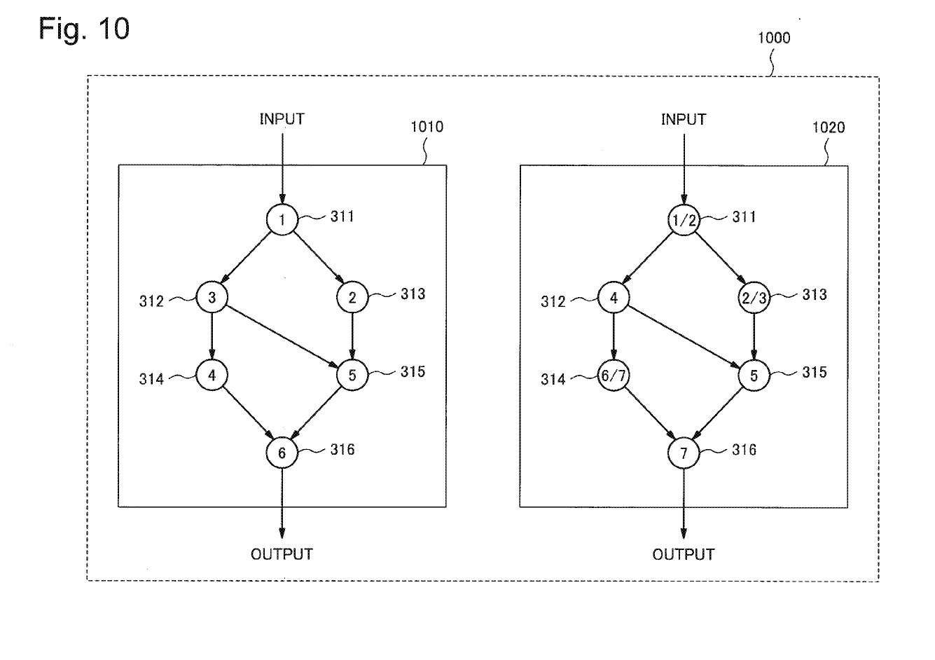

FIG. 10 is a diagram illustrating an example of a black box substitution order 1000 of the fifth exemplary embodiment of the invention. FIG. 10 shows the selection order of the module of FIG. 3A.

The left side of FIG. 10 represents an example in which modules (partial system models) 311 to 316 are substituted one by one with a black box, in order. The modules 311 to 316 are substituted in order of the number in a circle representing each module. The right side of FIG. 10 represents an example of a black box substituted in order under the condition that a combination (pair) including a plurality of modules (partial system models) is included as a processing subject. In this case, in order of the number in the circles, the module 311, the modules (311, 313), the module 313, the module 312, the module 315, the module 314, and the modules (314, 316) are substituted, in that order.

### <<Hardware Configuration of Information Processing Device>>

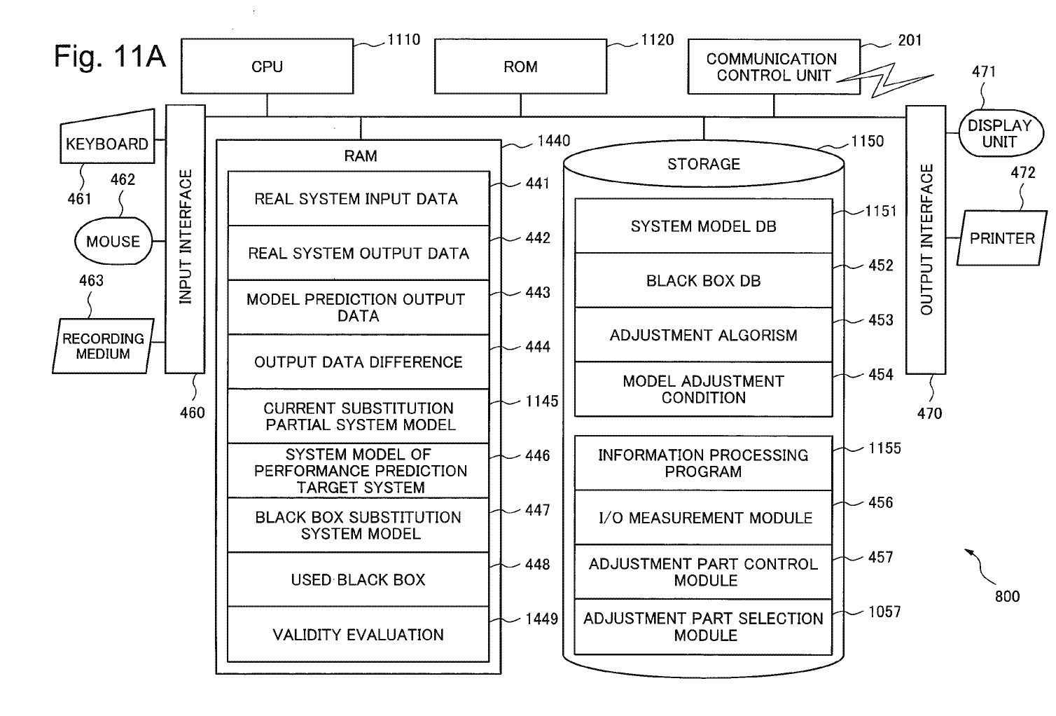

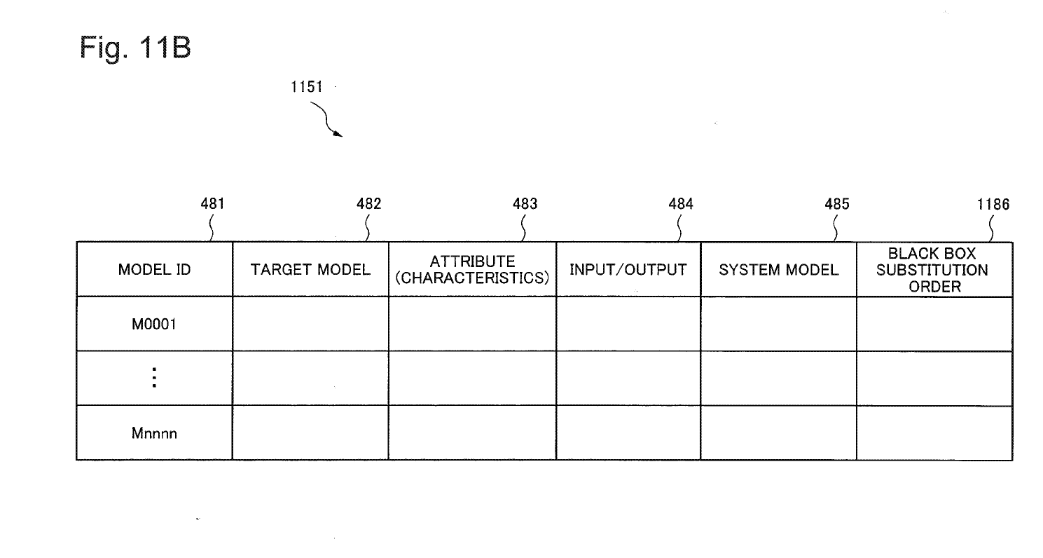

FIG. 11A is a block diagram illustrating a hardware configuration of the information processing device 800 of the fifth exemplary embodiment of the invention.

In FIG. 11A, a CPU 1110 is a processor for computation (calculation) control which is executed by programs and achieves a configuration of each function in FIG. 8. A ROM 1120 stores fixed data and programs, i.e. initial data and programs, and programs. The communication control unit 201 communicates with the performance prediction target system through a network.

A RAM 1140 is a random access memory which the CPU 1110 uses as a work area for temporary storage. The RAM 1140 includes an area which stores data required for achievement of the exemplary embodiment. In FIG. 11A, the same data as that of FIG. 4 described in the second exemplary embodiment has the same numeral number and explanations on the same data are omitted in the exemplary embodiment.

A substitution partial system model 1145 and validity evaluation 1449 are temporarily stored inside the RAM 1140 in FIG. 11A. The substitution partial system model 1145 is information representing a partial system model which is currently (i.e. at the present moment) substituted with a black box. The validity evaluation 1449 is information representing validity evaluation for a system model in which adjustment of a black box is completed.

A storage 1150 stores database, various parameters, or following data or programs required for achievement of the exemplary embodiment. The same data as that of FIG. 4 described in the second exemplary embodiment has the same numeral number and explanations on the same data are omitted in the exemplary embodiment. A numeral number 1151 denotes a system model DB of the exemplary embodiment (refer to FIG. 11B). The storage 1150 stores following programs. A numeral number 1155 denotes an information processing program executing whole processing. A numeral number 1057 denotes an adjustment part selection module achieving capability to select a partial system model to be substituted with a black box, in order.

In FIG. 11A, only data and programs required for the exemplary embodiment are illustrated and general-purpose data and programs, e.g. OS, are not illustrated.

### (System Model DB)

FIG. 11B is a diagram illustrating a configuration of a system model DB 1151 of the fifth exemplary embodiment of the invention.

The system model DB 1151 of the exemplary embodiment stores a black box substitution order 1186 corresponding to a system model, in addition to data (481 to 485) of the system model DB 451 in FIG. 4B above mentioned. The black box substitution order 1186 is used as the substitution order data 807a.

### <<Control Procedure of Information Processing>>

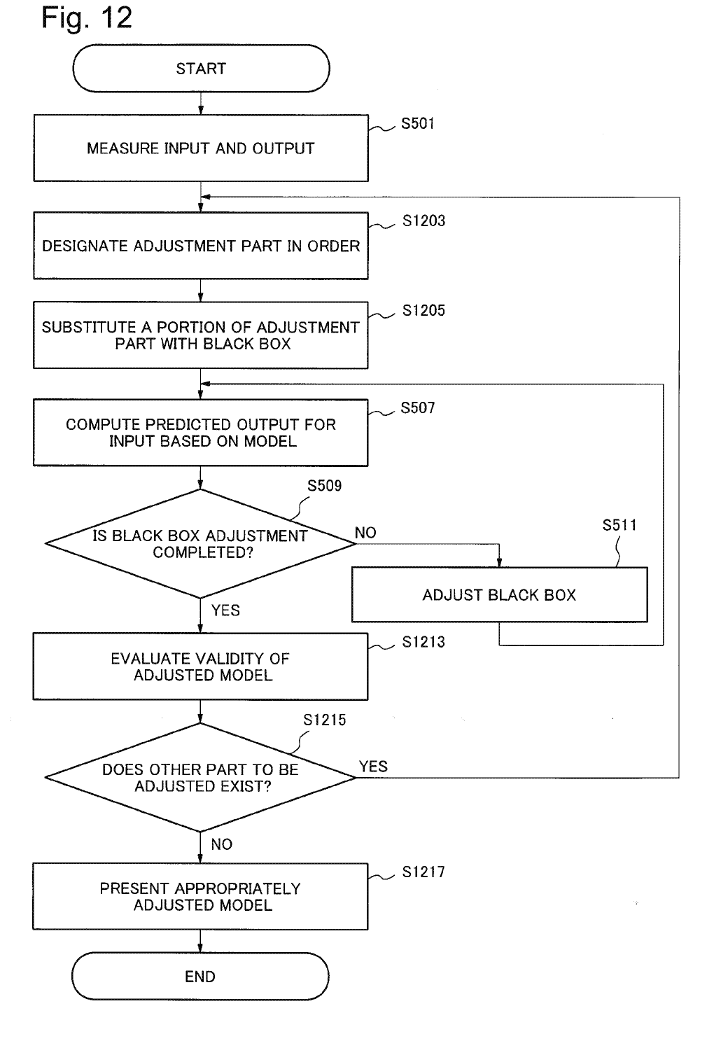

FIG. 12 is a flowchart illustrating a control procedure of the information processing device of the fifth exemplary embodiment of the invention. In the information processing device 800 shown in FIG. 11A, the CPU 1110 carries out the procedures described in the flowchart while using the RAM 1440, and achieves the configuration of each function shown in FIG. 11A. In FIG. 12, a step of the same process as that of the flowchart shown in FIG. 5 of the second exemplary embodiment above mentioned (i.e. step in which CPU 410 carries out by referring to RAM 440) has the same numeral number, and therefore descriptions of the same processes in the exemplary embodiment are omitted.

In the exemplary embodiment, after measuring input-output in step S 501, the CPU 1110 designates a partial system model in order (step S1203). The order of the partial system models designated by the CPU 1110 does not necessarily have to include all the partial system models. In an example shown in FIG. 3A, for example, when it is clearly determined that there is no need to adjust the module 311, the CPU 1110 may exclude the module 311 from the order, and designate the other modules 312 to 316 in order. The CPU 1110 may set, as the order, an alphabetical order of an identifiable ID which is allocated to each module. The CPU 1110 may allocate a priority to each module and set an order of the priority.

In the exemplary embodiment, processing related to the step S1203 is not limited to the examples described above. In the exemplary embodiment, any method that is able to uniquely identify an order of modules may be adopted as processing method related to the step S1203 In step S1203, when a plurality of parts of a system are adjusted, the CPU 1110 may determine the order based on combinations. When it is preliminarily understood that there is no need to adjust the module 311, the CPU 1110 chooses combinations from the other modules 312 to 316.

As partially shown in FIG. 9B, if a combination (pair) including two parts (341, 342) of system model is adjusted, the information processing device of the exemplary embodiment may determine an order such that a next pair is (312, 314), and a pair after the next pair is (312, 315). When determining the order, the information processing device of the exemplary embodiment may determine an order without fixing the number of parts to be adjusted, which can be e.g. one, two, or three. In this case, an upper limit of the number of the parts to be adjusted may be limited to a preliminarily given number. For example, if the limited number of parts is three, the order of parts to be adjusted becomes like the above descriptions.

Next, the CPU 1110 substitutes a portion of the partial system model of the designated model with a black box (step S1205). As an example, when designating the module 313 in the system model 310 shown in FIG. 3A, the CPU 1110 substitutes a part of the module 313 with a black box. The part of the module to be substituted with a black box is designated in advance, when the system model 310 is configured. The part of the module may be a processing time when the module is a queue. If the module is represented by the equation, e.g. y=a*exp(b*u) (here, u is input, y is output, a,b are coefficients), the part of the module may be a parameter, e.g. the coefficient thereof.

In the exemplary embodiment, the part of the partial system is not limited to the example described above. In the exemplary embodiment, the part of the partial system model may be “a part” which does not widely depart from a requirement of the module, i.e. “simulation of a partial element in a system”, by substitution with a black box.

The module 313, a part of which is substituted with a black box, receives an input from the module 311, and sends an output to the module 315, as with a time before the substitution. If a plurality of parts to be adjusted exist, a part of each module is substituted with a black box.

The CPU 1110 conducts processing similar to the exemplary embodiment in step S507, step S509, and step S511.

The CPU 1110 evaluates validity of the system model in which a black box is adjusted (step S1213). In the exemplary embodiment, the evaluation criterion explained in the fourth exemplary embodiment is used as an evaluation criterion for validity evaluation of the system model. Explanations on the criterion are omitted in the exemplary embodiment.

As a result of determination in step S1215, the CPU 1110 returns to step S1205 and repeats processing if a part to be next adjusted on a system model exist, and carries out step S1217 if the part to be next adjusted does not exist.

The CPU 1110 presents an appropriately adjusted model from among respective adjusted system models evaluated in step S1213 (step S1217). In the step, the CPU 1110 may present only system model which is evaluated as the most appropriate. The CPU 1110 may present the system model with evaluation values (the number of terms, a value of AIC, or the like) in order of validity.

### Sixth Exemplary Embodiment

An information processing system of a sixth exemplary embodiment of the invention is described below. In each exemplary embodiment described above, a configuration is described, in which a system targeted for performance prediction and an information processing device conducting the performance prediction of the system are included.

The information processing system of the exemplary embodiment differs from the above exemplary embodiment in a configuration in which a performance prediction system having a plurality of servers and carrying out performance prediction is included, and a performance prediction target system having a plurality of servers is included. In the exemplary embodiment, performance prediction for a system including a plurality of servers connected to a network can be conducted by a system including a plurality of servers that cooperates with each other. A configuration of each function and operations of the exemplary embodiment may adopt same or similar configurations of the above exemplary embodiment, and therefore detailed descriptions are omitted. In the exemplary embodiment, a configuration of the information processing system is described.

### <<Configuration of Information Processing System>>

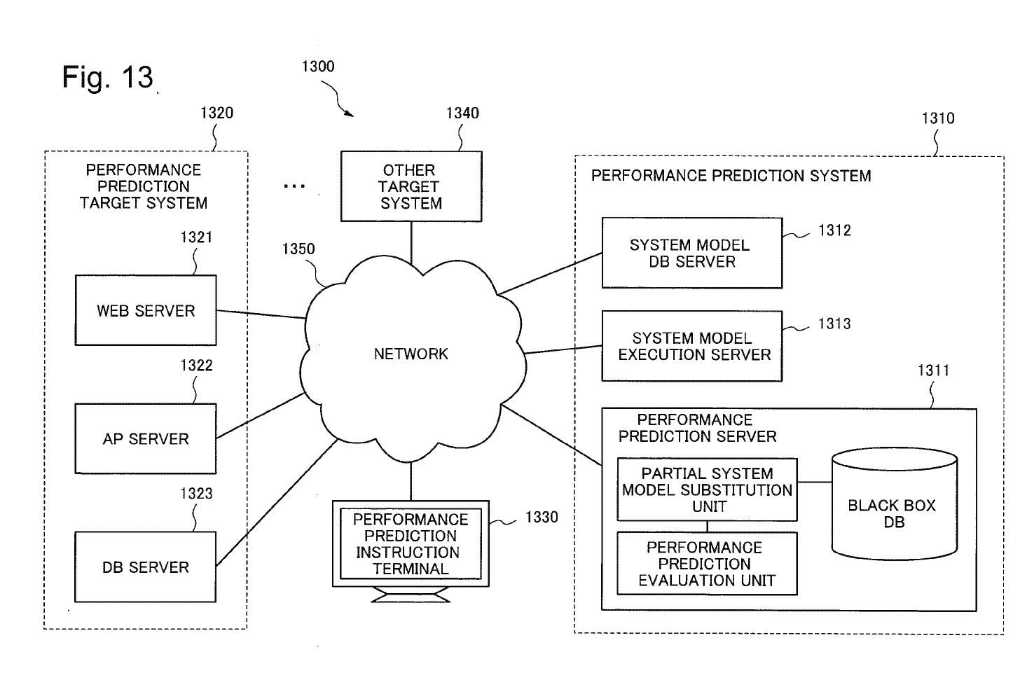

FIG. 13 is a block diagram illustrating a configuration of an information processing system 1300 of the sixth exemplary embodiment of the invention.

A performance prediction target system 1320 includes a Web server 1321, an AP server 1322, and a DB server each connecting to a network 1350. A performance prediction system 1310 include a performance prediction server 1311, a system model DB server 1312, and a system model execution server 1313 each connecting to a network 1350. The performance prediction server 1311 carries out substitution and evaluation of a partial system model of a black box. The system model DB server 1312 manages a system model DB. The system model execution server 1313 executes simulation based on a system model.

In the information processing system 1300 shown in FIG. 13, selection of a partial system model which is substituted with a black box, and informing of an evaluation result are carried out by a performance prediction instruction terminal 1330d connecting to the network 1350. The network 1350 connects to various target systems 1340.

### Other Exemplary Embodiment

With respect to a system targeted for performance prediction, the invention is applicable to performance prediction reflecting an actual behavior (action) of the system. For example, when the invention is applied to an information processing system, accurate performance prediction can be achieved even though the system targeted for performance prediction includes a behavior which is unknown without actual operations.

In the information processing device of the invention, not only whole of system, but a module which is a part of the system can be substituted with a black box. Therefore, the information processing device of the invention can improve accuracy of the performance prediction for a model of a system similar to the above described system.

The information processing device of the invention can make a model of a system similar to the above described system by keeping a part which is substituted with a black box same as the above described system, and changing a parameter of a module (which is not substituted with a black box).

In this case, since a black box already adjusted based on an actual behavior of the system is included, therefore, it is expected that accuracy of performance prediction for the model of the system similar to the above described system may be correspondingly improved.

By the method for substituting the whole model of a system (310 in FIG. 3A) with the black box (described in Patent Literature 3), improvement of prediction accuracy of a model of a similar system is not expectable.

Generally, it is not able to configure the model of the similar system if the whole model is substituted with a black box, since it is unclear how parameters of the information processing system (e.g. driving frequency of CPU, or the like) are reflected to the black box. Contrarily, in the information processing device of the invention, if only module which is a part of a system is substituted with a black box, parameters of the information processing system can be reflected to a module other than the substituted black box. Therefore, in the information processing device of the invention, a model of a similar system can be configured.

The exemplary embodiment of the invention is described above in detail. A system or devices in which separate characteristics included in each exemplary embodiment are combined in any manner are within the scope of the invention.

The invention may be applied to a system including a plurality of devices, or a single device. The invention may be applied to the case in which a control program which achieves functions of the exemplary embodiments is given to a system or a device directly or from remote places. Therefore, a control program which is installed in a computer in order to achieve the functions of the invention by the computer, a medium storing the control program, WWW (World Wide Web) server from which the control program can be downloaded are within the scope of the invention.

### Other Expressions of the Exemplary Embodiments

A part or all of the exemplary embodiments can be described as following supplemental notes, but are not limited to the following descriptions.

### (Supplemental Note 1)

An information processing device, including:

I/O measurement means for measuring input and output of a performance prediction target system that is a subject of performance prediction;

adjustment part substitution means for, with respect to a system model of the performance prediction target system that is configured from a plurality of partial system models, substituting a designated partial system model with a black box that is connected to input and output of the designated partial system model;

predicted output calculation means for, on the basis of the system model of the performance prediction target system in which the designated partial system model is substituted with the black box by the adjustment part substitution means, calculating predicted output of the system model for the input measured by the I/O measurement means; and

model adjustment means for adjusting a relation between the input and the output in the black box such that a difference between the output of the performance prediction target system measured by the I/O measurement means and the predicted output of the system model calculated by the predicted output calculation means is made smaller.

### (Supplemental Note 2)

The information processing device of the supplemental note 1, further including,

a reception means for receiving input from a user who designates the partial system model substituted by the adjustment part substitution means.

### (Supplemental Note 3)

The information processing device of supplemental note 1 or supplemental note 2, further including,

designation means for designating the partial system model substituted by the adjustment part substitution means.

### (Supplemental Note 4)

The information processing device of any one of supplemental note 1 to supplemental note 3, wherein the part substitution means substitutes a part of the designated partial system model with the black box.

### (Supplemental Note 5)

The information processing device of any one of supplemental note 1 to supplemental note 4, further including,

evaluation means for evaluating validity of the system model of the performance prediction target system after the model adjustment means adjusts the black box that is substituted with the partial system model.

### (Supplemental Note 6)

The information processing device of any one of supplemental note 1 to supplemental note 5, wherein

the black box includes a configuration which is able to determine an appropriate output with respect to an input by at least one of learning and regression, and is one of a neural network, a hidden Markov model, a polynomial function, and a non-parametric regression function.

### (Supplemental Note 7)

The information processing device of supplemental note 5 or supplemental note 6, wherein

the evaluation means determines validity of the system model of the performance prediction target system is higher, if the black box after adjustment by the model adjustment means includes a simpler configuration, if Akaike Information Criterion (AIC) is smaller, or if Bayesian Information Criterion (BIC) is lower.

### (Supplemental Note 8)

The information processing device of any one of supplemental note 5 to supplemental note 7, wherein

the designation means designates the partial system model included in the system model in a predetermined order, and the evaluation means evaluates validity of the system model of the performance prediction target system after the model adjustment means adjusts the black box that is substituted with each partial system model,

the information processing device further including,

presentation means for presenting to a user the system model of the performance prediction target system after adjustment by the model adjustment means, the system model being evaluated as highly appropriate by the evaluation means.

### (Supplemental Note 9)

The information processing device of any one of supplemental note 1 to supplemental note 8, wherein

the adjustment part substitution means substitutes a plurality of the partial system models with the one or more black boxes.

### (Supplemental Note 10)

The information processing device of any one of supplemental note 1 to supplemental note 9, further including,

model accumulation means for accumulating the system model of the performance prediction target system on the basis of a plurality of the partial system models that compose the system model.

### (Supplemental Note 11)

A system performance prediction method that is conducted by an information processing device, including,

measuring input and output of a performance prediction target system that is a subject of performance prediction;

for a system model of the performance prediction target system which is configured from a plurality of partial system models, substituting a designated partial system model with a black box which is connected to input and output of the partial system model;

on the basis of the system model of the performance prediction target system in which the designated partial system model is substituted with the black box, in the substitution, calculating predicted output of the system model for the input measured for the performance prediction target system; and

adjusting a relation between input and output in the black box such that a difference between the output measured for the performance prediction target system and the calculated predicted output of the system model is made smaller.

### (Supplemental Note 12)

A control program causing a computer to execute the functions of:

an I/O measurement function for measuring input and output of a performance prediction target system that is a subject of performance prediction;

an adjustment part substitution function, for a system model of the performance prediction target system that is configured from a plurality of partial system models, substituting a designated partial system model with a black box which is connected to input and output of the partial system model;

a predicted output calculation function, on the basis of the system model of the performance prediction target system in which the designated partial system model is substituted with the black box by the adjustment part substitution function, calculating predicted output of the system model for the input measured by the I/O measurement function; and

a model adjustment function for adjusting a relation between the input and the output in the black box such that a difference between the output of the performance prediction target system measured by the I/O measurement function and the predicted output of the system model calculated by the predicted output calculation function is made smaller.

### (Supplemental Note 13)

A performance prediction method that is conducted by an information processing device, including,

measuring input and output of a performance prediction target system that is a subject of performance prediction; for a system model of the performance prediction target system that is configured from a plurality of partial system models, substituting a designated partial system model with a black box which is connected to input and output of the partial system model;

on the basis of the system model of the performance prediction target system in which the designated partial system model is substituted with the black box, in the substitution, calculating predicted output of the system model for the input measured for the performance prediction target system;

adjusting a relation between input and output in the black box such that a difference between the output measured for the performance prediction target system and the calculated predicted output of the system model is made smaller; and

setting the predicted output measured on the system model as a result of performance prediction on the performance prediction target system, if the difference between the output measured for the performance prediction target system and the calculated predicted output of the system model becomes the smallest on the basis of the adjustment on the black box.

While having described an invention of the present application referring to the embodiments, the invention of the present application is not limited to the above mentioned embodiments. It is to be understood that to the configurations and details of the invention of the present application, various changes can be made within the scope of the invention of the present application by those skilled in the art.

This application claims priority from Japanese Patent Application No. 2011-134566 filed on Jun. 16, 2011, the contents of which are incorporation herein by reference in their entirety.

### REFERENCE SIGNS LIST

100 200 600 700 800 information processing device
101 I/O measurement unit
101a measured input
101b measured output
102 adjustment part substitution unit
103 prediction output calculation unit
103a predicted output
104 model adjustment unit
105 system model
105a partial system model
106 substitution model
106a black box
110 210 performance prediction target system (system targeted for predicting performance)
201 communication control unit
202 I/O measurement unit
203 performance prediction unit
204 model adjustment unit
205 model accumulation unit
206 adjustment part substitution unit
207 substitution part reception unit
220 1350 network (communication network)
300 458 system model
301 310 original system model
302 303 320 system model, a part of which is substituted with a black box
311 to 316 partial system model (module)
323 designated partial system model (black box)
330 1321 Web server
330 341 351 410 1110 CPU
332 333 342 343 352 353 storage device (hard disc drive: DK)
340 1322 application server (AP server)
350 1323 DB server (DB server)
360 client
370 black box (B·B)
380 black box server (B·B server)
420 1120 ROM
440 1440 RAM
450 1150 storage
451 system model DB
452 black box DB
543 model adjustment algorism
454 model adjustment condition
460 input interface
461 keyboard
462 mouse
463 recording medium
470 output interface
471 display unit
472 printer
607 807 model adjustment part designation unit
708 model validity evaluation unit
807 substitution order data
809 adjustment model presentation unit
1000 black box substitution order example
1300 information processing system
1310 performance prediction system
1311 performance prediction server
1312 system model DB server
1313 system model execution server
1320 performance prediction target system (system targeted for predicting performance)
1330 performance prediction instruction terminal
1340 other target system

What is claimed is:

1. An information processing device, comprising:
an I/O measurement unit which measures input and output of a performance prediction target system that is a subject of performance prediction;
an adjustment part substitution unit, with respect to a system model of the performance prediction target system that is configured from a plurality of partial system models, which substitutes a designated partial system model with a black box that is connected to input and output of the designated partial system model;
a predicted output calculation unit, on the basis of the system model of the performance prediction target system in which the designated partial system model is substituted with the black box by the adjustment part substitution unit, which calculates predicted output of the system model for the input measured by the I/O measurement unit; and
a model adjustment unit which adjusts a relation between the input and the output in the black box such that a difference between the output of the performance prediction target system measured by the I/O measurement unit and the predicted output of the system model calculated by the predicted output calculation unit is made smaller.

2. The information processing device of claim 1, further comprising:
a reception unit which receives input from a user that designates the partial system model substituted by the adjustment part substitution unit.

3. The information processing device of claim 1, further comprising:
a designation unit which designates the partial system model substituted by the adjustment part substitution unit.

4. The information processing device of claim 1, further comprising:
an evaluation unit which evaluates validity of the system model of the performance prediction target system after the model adjustment unit adjusts the black box that is substituted with the partial system model.

5. The information processing device of claim 4,
wherein
the designation unit designates the partial system model included in the system model in a predetermined order, and
the evaluation unit evaluates validity of the system model of the performance prediction target system after the model adjustment unit adjusts the black box that is substituted with each partial system model,
the information processing device further comprising:
a presentation unit which presents to a user the system model of the performance prediction target system after adjustment by the model adjustment unit, the system model of the performance prediction target system being evaluated as highly appropriate by the evaluation unit.

6. The information processing device of claim 1, wherein the adjustment part substitution unit substitutes a plurality of the partial system models with the one or more black boxes.

7. The information processing device of claim 1, further comprising:
a model accumulation unit which accumulates the system model of the performance prediction target system on the basis of a plurality of the partial system models that compose the system model.

8. A system performance prediction method that is conducted by an information processing device, comprising:
measuring input and output of a performance prediction target system that is a subject of performance prediction;
for a system model of the performance prediction target system that is configured from a plurality of partial system models, substituting a designated partial system model with a black box that is connected to input and output of the designated partial system model;
on the basis of the system model of the performance prediction target system in which the designated partial system model is substituted with the black box, in the substitution, calculating predicted output of the system model for the input measured for the performance prediction target system; and
adjusting a relation between input and output in the black box such that a difference between the output measured for the performance prediction target system and the calculated predicted output of the system model is made smaller.

9. A non-transitory computer readable storage medium storing a control program causing a computer to execute:
an I/O measurement function for measuring input and output of a performance prediction target system that is a subject of performance prediction;
an adjustment part substitution function, for a system model of the performance prediction target system that is configured from a plurality of partial system models, substituting a designated partial system model with a black box which is connected to input and output of the designated partial system model;
a predicted output calculation function, on the basis of the system model of the performance prediction target system in which the designated partial system model is substituted with the black box by the adjustment part substitution function, calculating predicted output of the system model for the input measured by the I/O measurement function; and
a model adjustment function for adjusting a relation between the input and the output in the black box such that a difference between the output of the performance prediction target system measured by the I/O measurement function and the predicted output of the system model calculated by the predicted output calculation function is made smaller.

10. (canceled)

11. A system performance prediction method of claim 8, further comprising:
setting the predicted output measured on the system model as a result of performance prediction on the performance prediction target system, if the difference between the output measured for the performance prediction target system and the predicted output calculated on the system model becomes the smallest on the basis of the adjustment on the black box.
